(19) United States
(12) Patent Application Publication
(10) Pub. No.: US 2008/0231082 A1
(43) Pub. Date: Sep. 25, 2008

(54) WHEEL HOUSING LINER

(76) Inventor: Boney A. Mathew, Clarkston, MI (US)

Correspondence Address: Harold W. Milton, JR.;DICKINSON WRIGHT PLLC, Suite 2000, 38525 Woodward Avenue, Bloomfield Hills, MI, 48304-5092, US

(21) Appl. No.: 12/050,994

(22) Filed: Mar. 19, 2008

Related U.S. Application Data
(60) Provisional application No. 60/896,010, filed on Mar. 21, 2007.

(51) Int. Cl. B60R 27/00

(52) U.S. Cl. 296/198; 296/39.3

(57) ABSTRACT

A vehicle (20) includes a wheel housing (22) defining a wheel well (24). A liner (32) is disposed in the wheel well (24) and extends in an arcuate path about and spaced radially from a wheel (26). The liner (32) is of a polymer and includes a rubber dispersed therein for absorbing sound generated by the vehicle (20) and for absorbing vibrations generated by the vehicle (20). The liner (32) includes a rib (42) disposed adjacent to a fender (28) and extending longitudinally along the liner (32) in an arcuate path about the wheel (26) for deflecting debris propelled by the wheel (26) away from the fender (28) and the vehicle (20).

### CROSS REFERENCE TO RELATED APPLICATION

This application claims the benefit of application Ser. No. 60/896,010 filed Mar. 21, 2007.

### BACKGROUND OF THE INVENTION

1. Field of the Invention

The subject invention relates to a vehicle including a wheel housing liner, and more specifically, to a vehicle including a wheel housing liner for absorbing sound and vibrations.

2. Description of the Prior Art

Vehicles generally include at least one wheel housing defining a wheel well. A wheel is disposed in the wheel well, and typically, a liner is also disposed in the wheel well to prevent moisture and debris from entering the vehicle. The liner is generally spaced from the wheel. Most conventional liners are injection molded of a polymeric material and include at least one fastener disposed on the liner for securing the liner to the vehicle. An example of such a wheel well liner for a vehicle is disclosed in U.S. Pat. No. 6,155,624 to Bienenstein.

It is necessary that such prior art polymeric wheel housing liners be sufficiently rigid to maintain structural integrity and to withstand the impact of debris propelled by the wheel of the vehicle. It is also desirable that such liners absorb sound generated by the wheel and forces generated by debris propelled by the wheel. To provide sufficient rigidity, the prior art wheel housing liners comprise sufficiently dense, or high density, polymers. While such liners are able to maintain their form and are able to withstand the impact of debris propelled by the wheel of the vehicle, such liners are less sound and impact absorptive because of the denser materials.

Accordingly, there is always a need to improve a polymeric wheel housing liner in sound absorption and impact absorption properties.

### SUMMARY OF THE INVENTION AND ADVANTAGES

In addition to the structure described above, the present invention includes a rubber dispersed in the polymer for absorbing sound generated by the wheel and for absorbing forces generated by debris propelled by the wheel.

Accordingly, the tensile properties of rubber improve the sound absorption and impact absorption properties of the liner and the overall sound absorption and impact absorption effectiveness of the liner is improved.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a fragment of the vehicle using the liner of the subject invention;

FIG. 2 is a cross-sectional view of the vehicle as shown in FIG. 1 along 2-2; and

FIG. 3 is a perspective view of the liner.

### DETAILED DESCRIPTION OF THE INVENTION

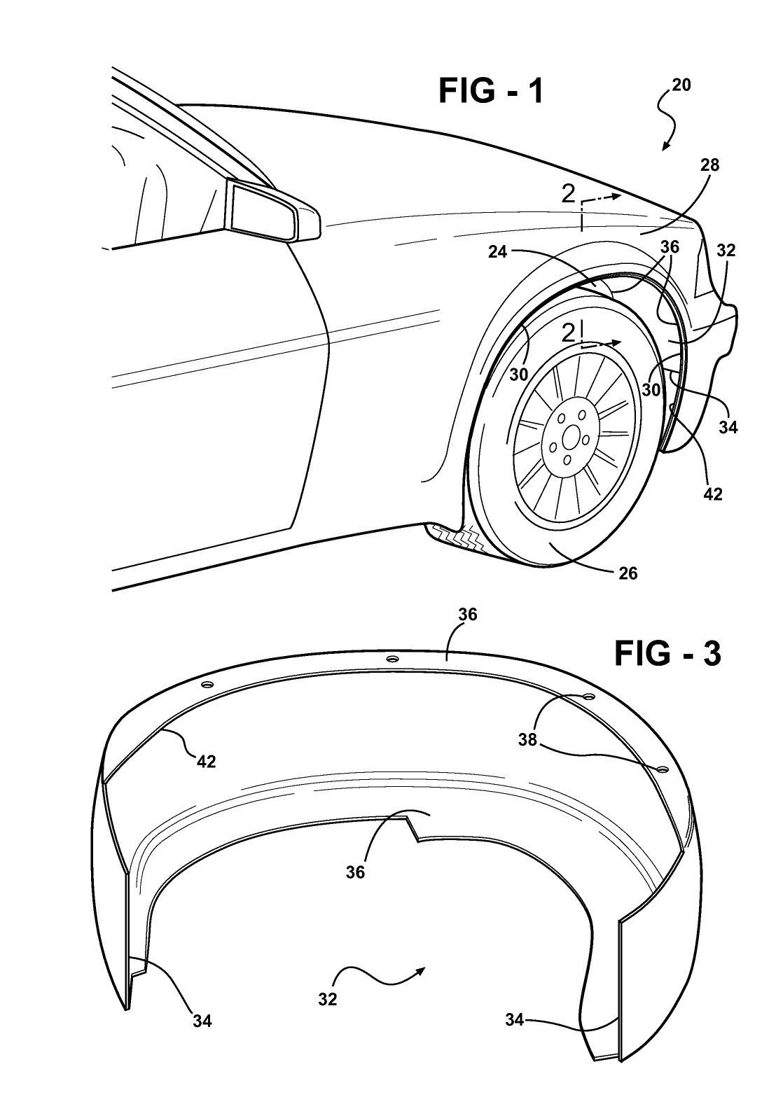

Referring to the Figures, wherein like numerals indicate corresponding parts throughout the several views, a vehicle 20 is generally shown in FIG. 1. The vehicle 20 is generally shown as an automobile in FIG. 1, however, those skilled in the art appreciate that the vehicle 20 can be any other type of vehicle commonly known in the art.

The vehicle 20 comprises at least one wheel housing 22 defining a wheel well 24 and includes a wheel 26 disposed in the wheel well 24. In an embodiment of the vehicle 20, as shown in FIG. 1, a fender 28 is disposed adjacent to the wheel housing 22 defining a fender opening 30 adjacent to the wheel well 24 for the wheel 26.

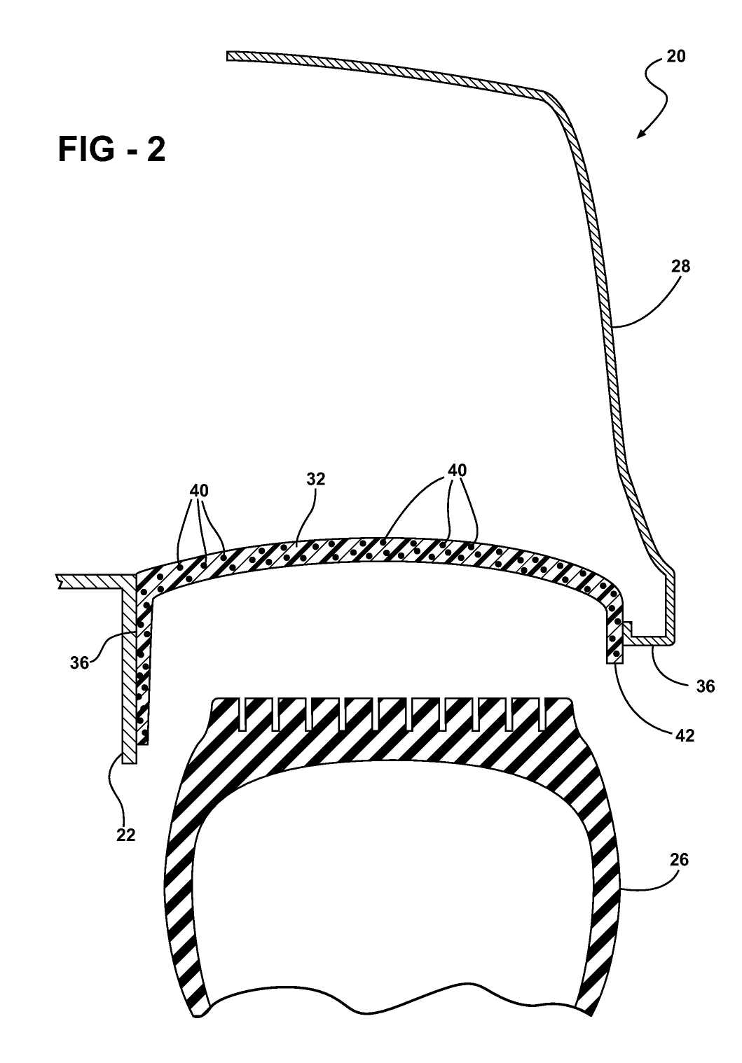

A liner 32 is generally shown in FIG. 3 and is defined by a sheet. As shown in FIG. 1, the liner 32 is disposed in the wheel well 24. The liner 32 has a pair of ends 34 and longitudinal inner and outer side edges 36 extending longitudinally along the vehicle 20 between the ends 34. The liner 32 generally extends in an arcuate path about and spaced radially from the wheel 26 as shown in FIG. 1. In an embodiment of the vehicle 20, as shown in FIG. 2, the outer side edge 36 of the liner 32 engages the fender 28 about and next adjacent to the fender opening 30 and the inner side edge 36 of the liner 32 engages the wheel housing 22.

The liner 32 is generally comprised of a polymer. Polymers such as polypropylene or high-density polyethylene may be used, however, those skilled in the art appreciate other polymers may also be used. The liner 32 is preferably injection molded and defines closed cells impermeable to water. A closed cell structure improves flexibility of the liner 32.

At least one fastener 38 is disposed on the liner 32 for securing the liner 32 to the vehicle 20. The fastener 38 can be molded on the liner 32 or snapped on the liner 32 to secure the liner 32 to the vehicle 20.

In an embodiment of the invention, the liner 32 includes a reinforcing material dispersed in the polymer. The reinforcing material is more rigid than the polymer for increasing the tensile strength of the liner 32. The reinforcing material is preferably either a mineral or fiber, or a combination thereof. Minerals suitable for such a purpose include, but are not limited to, Talc and CaCO₃. Fibers suitable for such a purpose include, but are not limited to, glass, polymer fiber, aramid fiber, and carbon fiber.

In an embodiment of the invention, the liner 32 includes a flame retardant dispersed in the polymer for inhibiting flammability of the liner 32.

In an embodiment of the invention, the liner 32 includes an adhesion promoter for adhering the polymer to dispersions therein. An adhesion promoter such as MOH, or any other adhesion or compatibleness promoter commonly known in the art, is suitable for such a purpose.

In an embodiment of the invention, a foaming agent is added to the liner 32 to create a plurality of pockets throughout the liner 32. Chemical foaming agents being exothermic or endothermic or physical blowing agents such as nitrogen or carbon dioxide are suitable for such a purpose.

The process of producing the liner 32 may produce an unpleasant odor. To eliminate or reduce such an odor, a functionalized olefin modifier can be added to the liner 32 for scenting the liner 32. In additional embodiments, a fragrance concentrate or a fragrance oil can be added to the liner 32 in addition to, or in lieu of, the functionalized olefin modifier for scenting the liner 32.

The liner 32 in the vehicle 20 is characterized by the liner 32 including a rubber dispersed in the polymer for absorbing sound generated by the wheel 26 and for absorbing forces generated by debris propelled by the wheel 26. The rubber generally consists of a plurality of rubber particulates 40 preferably having a mesh size in the range of 1 to 200 mesh. Cryogenically ground tire rubber is suitable for such a purpose.

The liner 32 is further characterized by including at least one rib 42 for deflecting debris propelled by the wheel 26 away from the fender 28 and the vehicle 20. The rib 42 preferably extends longitudinally along the liner 32 between the longitudinal inner and outer side edges 36 and in an arcuate path about and spaced radially from the wheel 26. In an embodiment of the invention as shown in FIG. 2, the rib 42 is disposed adjacent to the outer side edge 36 of the liner 32 and next adjacent to the fender opening 30. In the embodiment as shown in FIG. 2, the rib 42 extends radially inward of the liner 32 and into the fender opening 30 to deflect debris propelled by the wheel 26 away from the fender 28 and the vehicle 20.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. A vehicle (20) comprising;
at least one wheel housing (22) defining a wheel well (24),
a wheel (26) disposed in said wheel well (24),
a liner (32) defined by a sheet and disposed in said wheel well (24) and spaced from said wheel (26),
at least one fastener (38) disposed on said liner (32) for securing said liner (32) to said vehicle (20),
said liner (32) being of a polymer, and
characterized by said liner (32) including a rubber dispersed in said polymer for absorbing sound generated by said wheel (26) and for absorbing forces generated by debris propelled by said wheel (26).

2. A vehicle (20) as set forth in claim 1 wherein said liner (32) extends in an arcuate path about and spaced radially from said wheel (26).

3. A vehicle (20) as set forth in claim 2 wherein said rubber consists of a plurality of rubber particulates (40) having a mesh size in the range of 1 to 200 mesh.

4. A vehicle (20) as set forth in claim 2 wherein said liner (32) includes at least one rib (42) for deflecting debris propelled by said wheel (26) away from said vehicle (20).

5. A vehicle (20) as set forth in claim 4 wherein said liner (32) has a pair of ends (34) and longitudinal inner and outer side edges (36) extending longitudinally along said vehicle (20) between said ends (34).

6. A vehicle (20) as set forth in claim 5 wherein said rib (42) extends longitudinally along said liner (32) between said longitudinal inner and outer side edges (36) and spaced from said wheel (26).

7. A vehicle (20) as set forth in claim 6 wherein said rib (42) is disposed adjacent to said outer side edge (36) of said liner (32).

8. A vehicle (20) as set forth in claim 6 including a fender (28) disposed adjacent to said wheel housing (22) defining a fender opening (30) adjacent to said wheel well (24) for said wheel (26).

9. A vehicle (20) as set forth in claim 8 wherein said outer side edge (36) engages said fender (28) about and next adjacent to said fender opening (30).

10. A vehicle (20) as set forth in claim 9 wherein said rib (42) is disposed adjacent to said outer side edge (36) and next adjacent to said fender opening (30).

11. A vehicle (20) as set forth in claim 8 wherein said rib (42) extends inward of said liner (32) and into said fender opening (30).

12. A vehicle (20) as set forth in claim 2 wherein said liner (32) includes a reinforcing material dispersed in said polymer and being more rigid than said polymer for increasing tensile strength.

13. A vehicle (20) as set forth in claim 2 wherein said liner (32) includes a flame retardant dispersed in said polymer for inhibiting flammability of said liner (32).

14. A vehicle (20) as set forth in claim 2 wherein said liner (32) includes an adhesion promoter for adhering said polymer to adhesions therein.

15. A vehicle (20) comprising;
at least one wheel housing (22) defining a wheel well (24),
a wheel (26) disposed in said wheel well (24),
a fender (28) disposed adjacent to said wheel housing (22) defining a fender opening (30) adjacent to said wheel well (24) for said wheel (26),
a liner (32) defined by a sheet and disposed in said wheel well (24),
at least one fastener (38) disposed on said liner (32) for securing said liner (32) to said vehicle (20),
said liner (32) extending in an arcuate path about and spaced radially from said wheel (26),
said liner (32) having a pair of ends (34) and longitudinal inner and outer side edges (36) extending longitudinally along said vehicle (20) between said ends (34),
said outer side edge (36) engaging said fender (28) about and next adjacent to said fender opening (30),
said inner side edge (36) engaging said wheel housing (22),
said liner (32) being of a polymer,
said liner (32) including a reinforcing material dispersed in said polymer and being more rigid than said polymer for increasing tensile strength,
said liner (32) including a flame retardant dispersed in said polymer for inhibiting flammability of said liner (32),
said liner (32) including an adhesion promoter for adhering said polymer to dispersions therein,
said liner (32) including a functionalized olefin modifier for scenting said liner (32),
said liner (32) defining closed cells impermeable to water,
characterized by said liner (32) including a rubber dispersed in said polymer for absorbing sound generated by said wheel (26) and for absorbing forces generated by debris propelled by said wheel (26),
said rubber consisting of a plurality of rubber particulates (40) having a mesh size in the range of 1 to 200 mesh,
said liner (32) including at least one rib (42) for deflecting debris propelled by said wheel (26) away from said fender (28) and said vehicle (20),
said rib (42) extending longitudinally along said liner (32) between said longitudinal inner and outer side edges (36) and in an arcuate path about and spaced radially from said wheel (26),
said rib (42) disposed adjacent to said outer side edge (36) of said liner (32) and next adjacent to said fender opening (30), and
said rib (42) extending radially inward of said liner (32) and into said fender opening (30).

16. A liner (32) for absorbing sound and vibrations generated by a vehicle (20) comprising;
a polymer defining a sheet having a pair of ends (34) and longitudinal inner and outer side edges (36) extending between said ends (34),
said inner and outer edges extending in an arcuate path between said ends (34),
at least one fastener (38) for securing said liner (32) to the vehicle (20),
characterized by a rubber dispersed in said polymer for absorbing sound generated by the vehicle (20) and for absorbing vibrations generated by the vehicle (20).

17. A liner (32) as set forth in claim 16 wherein said rubber consists of a plurality of rubber particulates (40) having a mesh size in the range of 1 to 200 mesh.

18. A liner (32) as set forth in claim 16 including a reinforcing material dispersed in said polymer and being more rigid than said polymer for increasing tensile strength.

19. A liner (32) as set forth in claim 16 including a flame retardant dispersed in said polymer for inhibiting flammability of said liner (32).

20. A liner (32) as set forth in claim 16 including an adhesion promoter for adhering said polymer to dispersions therein.

21. A liner (32) as set forth in claim 16 including a functionalized olefin modifier for scenting said liner.

22. A liner (32) as set forth in claim 16 including at least one rib (42) for deflecting debris propelled by the vehicle (20) away from the vehicle (20).

23. A liner (32) as set forth in claim 21 wherein said rib (42) extends longitudinally along said liner (32) between said longitudinal inner and outer side edges (36).

24. A liner (32) as set forth in claim 22 wherein said rib (42) is disposed adjacent to one of said side edges (36).

25. A liner (32) as set forth in claim 16 wherein said polymer and dispersions therein define closed cells impermeable to water.
